(19) United States
(12) Patent Application Publication
(10) Pub. No.: US 2009/0068456 A1
(43) Pub. Date: Mar. 12, 2009

(54) PROTECTIVE LAYER TRANSFER SHEET

(75) Inventors: Kazuhiro Masuda, Tokorozawa-Shi (JP); Jiro Onishi, Tokyo-To (JP); Chie Fujimoto, Tsukuba-Shi (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 12/202,512

(22) Filed: Sep. 2, 2008

(30) Foreign Application Priority Data
Sep. 6, 2007 (JP) 2007-231676
Sep. 27, 2007 (JP) 2007-252394

(51) Int. Cl. B32B 33/00

(52) U.S. Cl. 428/347; 428/352

(57) ABSTRACT

According to a first aspect of the present invention, there is provided a protective layer transfer sheet comprising: a substrate sheet; a heat resistant slip layer provided on one side of the substrate sheet; and a thermally transferable protective layer provided on at least a part of the other side of the substrate sheet opposite to the one side where the heat resistant slip layer is provided, the protective layer comprising a peel layer, a primer layer, and an adhesive layer formed in this order from the substrate sheet side, and the peel layer being formed of an acrylic copolymer resin having a solution acid value of 2 or less.

### REFERENCE TO RELATED APPLICATIONS

This application is based upon and claims the benefit of priority under Paris Convention based on the prior Japanese Patent Applications Nos. 231676/2007 and 252394/2007; the entire contents of which are incorporated herein by reference.

### BACKGROUND OF THE INVENTION

1. Field of the Invention

### First Aspect of the Invention

A first aspect of the present invention relates to a protective layer transfer sheet, particularly a protective layer transfer sheet comprising: a substrate sheet; a heat resistant slip layer provided on one side of the substrate sheet; and a thermally transferable protective layer provided on at least a part of the other side of the substrate sheet opposite to the one side where the heat resistant slip layer is provided, wherein the protective layer comprises a peel layer, a primer layer, and an adhesive layer laminated in this order from the substrate sheet side. The protective layer transfer sheet is advantageous in that, in the protective layer transfer after long-term storage or after storage at elevated temperatures, separation failure in protective layer transfer due to increased peel force between the substrate sheet and the peel layer can be prevented.

### Second Aspect of the Invention

A second aspect of the present invention relates to a protective layer transfer sheet, particularly a protective layer transfer sheet which, even when energy applied in the protective layer transfer is varied due to a change in conditions such as the type of printers and environmental temperatures, and the surface temperature of thermal heads, causes no significant variation in peel force in the transfer of a protective layer onto an object to be transferred and consequently can realize stable and good protective layer transfer.

2. Description of Related Art

Letters and images have hitherto been formed onto objects by thermal transfer. A thermal sublimation-type transfer method and a thermal fusion-type transfer method have been widely used for thermal transfer. In the thermal sublimation-type transfer method, a sublimable dye is used as a coloring material, and the sublimable dye contained in a sublimable dye layer provided on a thermal transfer sheet is transferred onto an object such as a thermal transfer image receiving sheet by utilizing a heating device such as a thermal head or a laser beam of which the heat generation is controlled according to image information, thereby forming an image. According to this thermal sublimation-type transfer method, the amount of the dye to be transferred can be controlled dot by dot by heating for a very short period of time. Since the coloring material used is a dye, the formed image is very sharp and, at the same time, is highly transparent. Accordingly, the formed image is excellent in reproducibility of halftones and gradation, and very high-fineness images can be formed. This contributes to the provision of high-quality images comparable to full-color silver salt photographs. By virtue of the above advantage, the thermal transfer technology using the thermal sublimation-type transfer method have been widely used, for example, in photographs for business, printers for personal computers, and video printers.

The thermal sublimation-type transfer method can control the amount of dye transferred on a dot basis by the quantity of applied energy, and, thus, is advantageous for gradation image formation. In the thermal sublimation-type transfer method, however, unlike image formation with a conventional printing ink, the coloring material is not a pigment but a relatively low-molecular weight dye and, further, no vehicle is used. Accordingly, the formed image is disadvantageously poor in durability such as lightfastness, weathering resistance, and abrasion resistance. On the other hand, in the thermal fusion-type recording method, the formed image contains a vehicle. Nevertheless, the image is inferior to images formed using a conventional printing ink in durability, especially abrasion resistance.

A known method for enhancing the durability of prints formed by thermal transfer comprises superimposing a protective layer transfer sheet with a thermally transferable resin layer (a thermally transferable protective layer) on the image formed by the thermal sublimation-type transfer method or the thermal fusion-type recording method and transferring the thermally transferable resin layer, for example, with a thermal head or a heating roll to form a protective layer on the image. The provision of a protective layer on the image in the print can improve the abrasion resistance, chemical resistance, solvent resistance and the like of the image. The lightfastness of the image can also be improved by adding an ultraviolet absorber into the protective layer. Furthermore, special functions such as forgery prevention or improved whiteness of the print can be imparted to the protective layer by adding a fluorescent brightener or the like into the protective layer.

As described, for example, in Japanese Patent Laid-Open No. 35988/1992 and Japanese Patent Laid-Open No. 142988/1992, a protective layer transfer sheet having a construction comprising a substrate, a peel layer provided on the substrate, and an adhesive layer provided on the peel layer is known. In this case, the adhesive layer is provided to stably transfer the peel layer onto a thermal transfer image receiving sheet. Further, a heat resistant slip layer is provided on the side of the substrate opposite to the peel layer side to avoid, for example, thermal damage to the substrate of the protective layer transfer sheet in the thermal transfer of the peel layer onto the thermal transfer image receiving sheet.

In Japanese Patent Laid-Open No. 272872/2006, there is a working example where, in a protective layer transfer sheet comprising a substrate sheet, and a peel layer, a primer layer, and a heat seal layer laminated on the substrate sheet, Dianal BR-87, which is an acrylic resin, is used as a peel layer.

### First Aspect of the Invention

The above protective layer transfer sheet has a problem that, when the protective layer is thermally transferred after long-term storage or after storage at an elevated temperature of about 40° C., due to high peel force, separation failure of the protective layer transfer takes place.

### Second Aspect of the Invention

The conventional protective layer transfer sheet has a problem that, upon a variation in energy applied in the protective layer transfer, for example, due to a difference in type of a thermal transfer printer, a difference in temperature of an environment where the printer is installed, and a difference in surface temperature, caused by stored heat of a thermal head at the start of printing and continuous printing, a change in peel force in the transfer of the protective layer onto an object to be transferred is so large that separation failure takes place in the protective layer transfer.

### SUMMARY OF THE INVENTION

### First Aspect of the Invention

The first aspect of the present invention has been made under the above circumstances, and an object of the first aspect of the present invention is to provide a protective layer transfer sheet comprising: a substrate sheet; a heat resistant slip layer provided on one side of the substrate sheet; and a thermally transferable protective layer provided on at least a part of the other side of the substrate sheet opposite to the one side where the heat resistant slip layer is provided, the protective layer comprising a peel layer, a primer layer, and an adhesive layer formed in this order from the substrate sheet side, which protective layer transfer sheet, in the protective layer transfer after long-term storage or after high-temperature storage, can prevent separation failure in the protective layer transfer caused by increased peel force between the substrate sheet and the peel layer.

According to the first aspect of the present invention, there is provided a protective layer transfer sheet comprising: a substrate sheet; a heat resistant slip layer provided on one side of the substrate sheet; and a thermally transferable protective layer provided on at least a part of the other side of the substrate sheet opposite to the one side where the heat resistant slip layer is provided, the protective layer comprising a peel layer, a primer layer, and an adhesive layer formed in this order from the substrate sheet side, and the peel layer being formed of an acrylic copolymer resin having a solution acid value of 2 or less. The use of an acrylic copolymer having a solution acid value of 2 or less in the peel layer is advantageous in that, even when the protective layer transfer sheet is stored for a long period of time or at high temperatures, the peel force between the substrate sheet and the peel layer is not increased, therefore the occurrence of separation failure in the protective layer transfer can be prevented. An image formed object having excellent durability can be provided by transferring a protective layer, onto a print comprising an image formed on an object to be transferred, by thermal transfer using the protective layer transfer sheet of the present invention.

Preferably, the primer layer is formed using a composition containing colloidal ultrafine particles of an alumina sol. This can enhance the adhesion between the peel layer and the adhesive layer and thus can improve the separability of the protective layer from the substrate sheet in the thermal transfer of the protective layer. Preferably, the heat resistant slip layer is formed using a composition containing an isocyanate compound and a hydroxyl group-containing resin. Further, preferably, the heat resistant slip layer contains a polyamide-imide resin. When the heat resistant slip layer is formed using the composition containing the isocyanate compound and the hydroxyl group-containing resin, or contains the polyamide-imide resin, in both the cases, excellent heat resistance can be imparted to the heat resistant slip layer. That is, in the former case, excellent heat resistance can be imparted to the heat resistant slip layer with the incorporation of the isocyanate compound, and, in the latter case, excellent heat resistance can be imparted to the heat resistance slip layer without the incorporation of the isocyanate compound. In these cases, even when high energy is applied with a thermal head to the heat resistant slip layer side, for example, in the protective layer transfer, heat fusion to the substrate sheet can be prevented, therefore smooth travelling can be realized.

### Second Aspect of the Invention

The second aspect of the present invention has been made under the above circumstances, and an object of the second aspect of the present invention is to provide a protective layer transfer sheet comprising a substrate sheet, a heat resistant slip layer provided on one side of the substrate sheet, and a thermally transferable protective layer provided on at least a part of the other side of the substrate sheet opposite to the one side where the heat resistant slip layer is provided, which protective layer transfer sheet, even when the energy applied in the protective layer transfer is varied, for example, due to printer type and environmental temperature conditions, and thermal head surface temperature conditions, undergoes no significant change in the peel force in the transfer of the protective layer onto an object to be transferred and, thus, can realize stable and good protective layer transfer.

According to the second aspect of the present invention, there is provided a protective layer transfer sheet comprising: a substrate sheet; a heat resistant slip layer provided on one side of the substrate sheet; and a thermally transferable protective layer provided on at least a part of the other side of the substrate sheet opposite to the one side where the heat resistant slip layer is provided, the protective layer comprising a peel layer and an adhesive layer formed in this order from the substrate sheet side, and the peel layer being formed of an acrylic copolymer resin having a solution acid value of 2 or less. The use of an acrylic copolymer resin having a solution acid value of 2 or less in the peel layer is advantageous in that, even when the energy applied in the protective layer transfer is increased, for example, due to various variations of the thermal transfer printer and the variation of the environmental temperature, the peel force between the substrate sheet and the peel layer is not increased, therefore the occurrence of separation failure in the protective layer transfer can be prevented. An image formed object having excellent durability can be provided by transferring a protective layer, onto a print comprising an image formed on an object to be transferred, by thermal transfer using the protective layer transfer sheet of the present invention.

A sample is formed by disposing the protective layer transfer sheet and an object to be transferred on top of each other, heating the thus formed assembly with a printer, which can vary gradations in the range of from 0 to 255 gradations by a gradation control method, under two levels of heating conditions of 120 gradations and 180 gradations to adhere the object to the protective layer transfer sheet, and the peel force at 180 gradations: peel force at 120 gradations ratio is preferably less than 1.4 in the peel force between the peel layer and the substrate sheet as measured when separating the sample into the protective layer transfer sheet and the object by 180 degrees. Thus, stable and good protective layer transfer can be realized by reducing the peel force so that the peel force at 180 gradations does not reach 1.4 times the peel force at 120 gradations.

### BRIEF DESCRIPTION OF THE DRAWINGS

FIG. 1 is a schematic cross-sectional view showing one embodiment of the protective layer transfer sheet in the first aspect of the present invention;

FIG. 2 is a schematic cross-sectional view showing another embodiment of the protective layer transfer sheet in the first aspect of the present invention;

FIG. 3 is a schematic cross-sectional view showing still another embodiment of the protective layer transfer sheet in the first aspect of the present invention;

FIG. 4 is a schematic cross-sectional view showing a further embodiment of the protective layer transfer sheet in the first aspect of the present invention;

FIG. 5 is a schematic cross-sectional view showing one embodiment of the protective layer transfer sheet in the second aspect of the present invention;

FIG. 6 is a schematic cross-sectional view showing another embodiment of the protective layer transfer sheet in the second aspect of the present invention;

FIG. 7 is a schematic cross-sectional view showing still another embodiment of the protective layer transfer sheet in the second aspect of the present invention;

FIG. 8 is a schematic cross-sectional view showing a further embodiment of the protective layer transfer sheet in the second aspect of the present invention;

FIG. 9 is a graph showing the relationship between the pulse number (transfer gradation) and the peel force of protective layer transfer in a sample which has been allowed to stand at room temperature (20° C.); and

FIG. 10 is a graph showing the relationship between the pulse number (transfer gradation) and the peel force of protective layer transfer in a sample which has been stored in an atmosphere of temperature 40° C. and humidity 90% RH for 30 days.

### DETAILED DESCRIPTION OF THE INVENTION

### First Aspect of the Invention

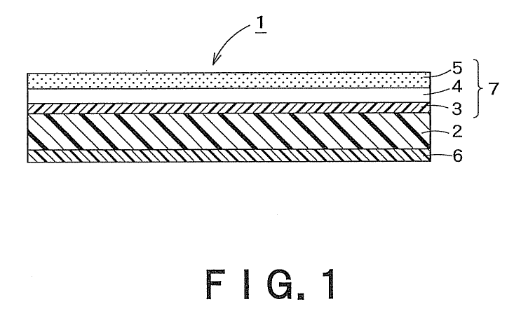

The first aspect of the present invention will be described. FIG. 1 is a schematic cross-sectional view showing one embodiment of a protective layer transfer sheet 1 in the first aspect of the present invention. The construction of the protective layer transfer sheet 1 is as follows. A peel layer 3, a primer layer 4, and an adhesive layer 5 are laminated in this order on one side of a substrate sheet 2. A heat resistant slip layer 6 is provided on the other side of the substrate sheet 2. The three layers of the peel layer 3, the primer layer 4, and the adhesive layer 5 constitute a protective layer 7. For example, the protective layer transfer sheet 1 is heated with a thermal head from the heat resistant slip layer 6 to transfer a protective layer 7 onto an object to be transferred.

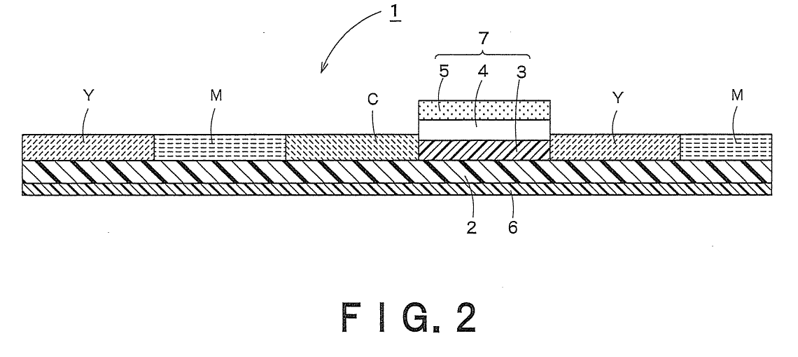

FIG. 2 is a schematic cross-sectional view showing another embodiment of the protective layer transfer sheet 1 in the first aspect of the present invention. The construction of the protective layer transfer sheet 1 is as follows. A heat resistant slip layer 6 is provided on one side of a substrate sheet 2. Dye layers containing sublimation dye as a thermally transferable coloring material layer are provided on the other side of the substrate sheet 2. Specifically, the dye layers comprise three color dye layers of a yellow dye layer Y, a magenta dye layer M, and a cyan dye layer C Further, after the formation of the cyan dye layer C, a protective layer 7 comprising three layers, i.e., a peel layer 3, a primer layer 4, and an adhesive layer 5 laminated on top of each other, is formed on the other side of the substrate sheet 2 in sequence. The dye layers and the protective layer 7 are repeatedly provided in a side-by-side relationship with each other. This embodiment is that a thermal transfer sheet comprises three color dye layers and a protective layer integrated with each other.

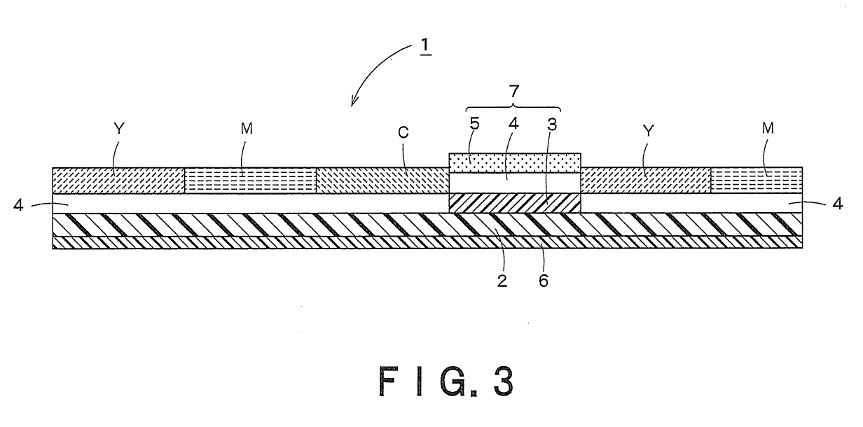

FIG. 3 is a schematic cross-sectional view showing still another embodiment of the protective layer transfer sheet 1 in the first aspect of the present invention. The construction of the protective layer transfer sheet 1 is as follows. A heat resistant slip layer 6 is provided on one side of a substrate sheet 2. Dye layers containing sublimation dye as a thermally transferable coloring material layer are provided on the other side of the substrate sheet 2 through a primer layer 4. Specifically, the dye layers comprise three color dye layers of a yellow dye layer Y, a magenta dye layer M, and a cyan dye layer C. Further, a protective layer 7 comprising three layers, i.e., a peel layer 3, a primer layer 4, and an adhesive layer 5 laminated on top of each other, is formed on the other side of the substrate sheet 2 in sequence. The dye layers and the protective layer 7 are repeatedly provided in a side-by-side relationship with each other. This embodiment is that three color dye layers are provided on a substrate sheet through a primer layer 4, and after the formation of the cyan dye layer C, a protective layer 7 comprising three layers of a peel layer 3, a primer layer 4, and an adhesive layer 5 laminated on top of each other, is formed in sequence. This embodiment is also a thermal transfer sheet comprising three color dye layers and a protective layer integrated with each other.

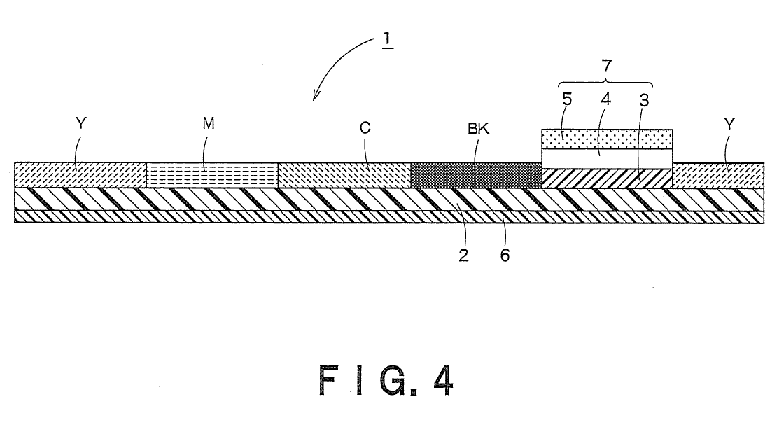

FIG. 4 is a schematic cross-sectional view showing a further embodiment of the protective layer transfer sheet 1 in the first aspect of the present invention. The construction of the protective layer transfer sheet 1 is as follows. A heat resistant slip layer 6 is provided on one side of a substrate sheet 2. Dye layers containing sublimation dye as a thermally transferable coloring material layer and a black thermal-fusion ink layer BK are provided on the other side of the substrate sheet 2. Specifically, the dye layers comprise three color dye layers of a yellow dye layer Y, a magenta dye layer M, and a cyan dye layer C. Further, a protective layer 7 comprising three layers, i.e., a peel layer 3, a primer layer 4, and an adhesive layer 5 laminated on top of each other, is formed on the other side of the substrate sheet 2 in sequence. The dye layers, the black thermal-fusion ink layer BK and the protective layer 7 are repeatedly provided in a side-by-side relationship with each other. This embodiment is that a thermal transfer sheet comprises four-color thermally transferable coloring material layers of three dye layers and a black thermal-fusion ink layer and a protective layer integrated with each other. In addition to the embodiments shown in FIGS. 2 and 3 in which the thermally transferable coloring material layer is integrated with the protective layer, for example, various modified embodiments are possible, for example, an embodiment wherein thermally transferable coloring material layers having other color hues in addition to Y, M, C, and BK are added, and an embodiment wherein a thermally transferable coloring material layer of BK and a protective layer are integrated with each other.

Each layer constituting the protective layer transfer sheet in the first aspect of the present invention will be described in more detail.

### (Substrate Sheet)

The substrate sheet 2 of the protective layer thermal transfer sheet used in the present invention may be any conventional sheet having a certain level of heat resistance and strength. The thickness of the substrate sheet is, for example, from 0.5 to 50 μm, preferably from 1 to 10 μm, more preferably from 2 to 6 μm. For example, polyethylene terephthalate films, 1,4-polycyclohexylene dimethylene terephthalate films, polyethylene naphthalate films, polyphenylene sulfide films, polystyrene films, polypropylene films, polysulfone films, aramid films, polycarbonate films, polyvinyl alcohol films, cellophanes, cellulose derivatives such as cellulose acetate, polyethylene films, polyvinyl chloride films, nylon films, polyimide films, and ionomer films may be mentioned as specific examples of such substrate sheets. Among them, a polyester film formed of polyethylene terephthalate, polyethylene naphthalate, or a mixture thereof is preferred, and polyethylene terephthalate films are more preferred.

### (Heat Resistant Slip Layer)

The heat resistant slip layer 6 is provided to prevent thermal fusion of a heating device such as a thermal head to the substrate sheet and to realize smooth travelling. Resins usable in the heat resistant slip layer include, for example, natural resins or synthetic resins as such or in a mixture form, for example, cellulosic resins such as ethyl cellulose, hydroxy cellulose, hydroxypropyl cellulose, methyl cellulose, cellulose acetate, cellulose butyrate, and cellulose nitrate; vinyl resins such as polyvinyl alcohol, polyvinyl acetate, polyvinyl butyral, polyvinyl acetal, and polyvinyl pyrrolidone; acrylic resins such as polymethyl methacrylate, polyethyl acrylate, polyacrylamide, and acrylonitrile-styrene copolymer; aromatic polyamide resin, polyimide resin, polyamide-imide resin; polyvinyl toluene resin; coumarone-indene resin; polyester resin; polyurethane resin; and silicone-modified or fluorine-modified urethane.

Slipperiness-imparting agents added to or recoated on the heat resistant slip layer formed of the above resin include phosphoric esters, metallic soaps, silicone oils, graphite powder, silicone graft polymers, fluoro graft polymers, acrylsilicone graft polymers, acrylsiloxanes, arylsiloxanes, and other silicone polymers. Preferred is a layer formed of a polyol, for example, a high-molecular polyalcohol compound, a polyisocyanate compound and a phosphoric ester compound. Further, the addition of a filler is more preferred.

The heat resistant slip layer may be formed by dissolving or dispersing the above resin, slipperiness-imparting agent, and a filler in a suitable solvent to prepare a coating liquid for a heat resistant slip layer, coating the coating liquid onto a substrate sheet by forming means such as gravure printing, screen printing, or reverse roll coating using a gravure plate, and drying the coating. The coated amount of the heat resistant slip layer is preferably from 0.1 to 2.0 g/m² on a dry state.

In order to more enhance the heat resistance of the heat resistant slip layer, preferably, among the above resins, resins containing a reactive group of a hydroxyl group, that is, a hydroxyl group-containing resin (for example, a butyral resin or an acetal resin), are used in combination with an isocyante compound or the like as a crosslinking agent to form a crosslinking resin layer. Specifically, hydroxyl group-containing resins are not particularly limited so far as they can react with the isocyanate compound. Such hydroxyl group-containing resins include, for example, polyvinyl butyrals, polyvinyl acetals, polyvinyl formals, polyester polyols, acryl polyols, polyether polyols, urethane polyols, and polyesters. Among other, in the present invention, polyvinyl butyrals are suitable.

Any isocyanate compound used, for example, for conventional coating materials, adhesives, and polyurethane synthesis may be use without particular limitation. Such isocyanate compounds include polyisocyanates such as diisocyanate and triisocyanate. Specific examples of polyisocyanates used in the present invention include p-phenylene diisocyanate, 1-chloro-2,4-phenyl diisocyanate, 2-chloro-1,4-phenyl diisocyanate, 2,4-toluene diisocyanate, 2,6-toluene diisocyanate, hexamethylene diisocyanate, 4,4′-biphenylene diisocyanate, triphenylmethane triisocyanate, and 4,4,′4″-trimethyl-3,3′,2′-triisocyanate-2,4,6-triphenyl cyanurate.

Preferably, the heat resistant slip layer according to the present invention is formed using a composition which is a coating liquid for a heat resistant slip layer containing an isocyanate compound and a hydroxyl group-containing resin. The isocyanate compound and the hydroxyl group-containing resin contained in the heat resistant slip layer usually exist as a mutually polymerized polymer.

Further, in the present invention, the incorporation of a polyamide-imide resin in the heat resistant slip layer can improve the heat resistance and is preferred. Specifically, as described in Japanese Patent Laid-Open No. 334760/2001, preferably, the heat resistant slip layer is formed of a material comprising a mixture, as a binder, of a specific amount of a polyamide-imide resin having a Tg value of 200° C. or above as measured by differential thermal analysis with a specific amount of a polyamdie-imide silicone resin and further a specific amount of a polyvalent metal salt of an alkylphosphoric ester and a specific amount of a filler mixed into the material. In this case, unlike the case where the resin is crosslinked using an isocyanate compound, in the heat resistant slip layer, excellent heat resistance and slipperiness can be imparted without any crosslinking reaction by coating a coating liquid containing the material onto a substrate sheet and drying the coating.

### (Peel Layer)

The peel layer 3 in the protective layer transfer sheet according to the present invention is formed of an acrylic copolymer resin having a solution acid value of 2 or less. Examples of such resins include polymers produced by copolymerizing, for example, methyl methacrylate or styrene, with a monomer such as 2-hydroxyethyl methacrylate, N-methylolacrylamide, N-methylolmethacrylamide, 2-hydroxyethyl acrylate, 2-hydroxyethyl methacrylate, 2-hydroxypropyl acrylate, 2-hydroxypropyl methacrylate, 4-hydroxybutyl acrylate, 4-hydroxybutyl methacrylate, acrylic acid, methacrylic acid, 2-carboxy-1-butene, 2-carboxy-1-pentene, 2-carboxy-1-hexene, and 2-carboxy-1-heptene.

In the present invention, the acid value of the acrylic copolymer resin constituting the peel layer as measured in a solution state is 2 mg KOH/g or less. When the acid value is more than 2 mg KOH/g, the peel force increases between the substrate sheet and the peel layer in the protective layer transfer after long-term storage or after high-temperature storage and, consequently, separation failure takes place in the protective layer transfer. In order to produce an acrylic copolymer resin having an acid value of 2 mg KOH/g or less, a method may be adopted in which an acrylic monomer of the copolymer resin per se or an acrylic monomer composition comprising an acrylic monomer and other monomer(s) is regulated so as to have an acid value of 2 mg KOH/g or less and then polymerizing the acrylic monomer composition.

The peel layer may contain various additives such as waxes, inorganic fine particles or organic fine particles, ultraviolet absorbers, antioxidants, and fluorescent brightening agents in such amounts that do not impair the transparency of the protective layer. Such waxes include, for example, polyethylene waxes, polyester waxes, polystyrene powders, olefin powders, microcrystalline waxes, carnauba waxes, paraffin waxes, Fischer-Tropsh waxes, various low-molecular weight polyethylenes, Japan waxes, beeswaxes, spermaceti waxes, wool waxes, shellac waxes, candelilla waxes, petrolactam, partially modified waxes, fatty acid esters, and fatty amides. The use of these waxes can improve the scratch resistance and layer transferability of the peel layer.

For example, silica, alumina, titania, and calcium carbonate are usable as the inorganic fine particle of the additive. Organic fine particles include styrene fine particles, acrylic fine particles, and melamine resin fine particles. The addition of these fine particles is effective in improving the layer transferability and preventing rainbow-colored unevenness. Further, an ultraviolet absorber may be added to improve the lightfastness and weathering resistance of image and the like of an object covered with the protective layer. Ultraviolet absorbers include, for example, a wide variety of conventional organic ultraviolet absorbers, for example, salicylate, benzophenone, benzotriazole, substituted acrylonitrile, nickel chelate, or hindered amine ultraviolet absorbers. Further, an ultraviolet absorbing resin produced by introducing, for example, an addition-polymerizable double bond, such as a vinyl, acryloyl, or methacryloyl group, or an alcoholic hydroxyl, amino, carboxyl, epoxy, isocyanate or other functional group, into the ultraviolet absorber may be introduced into the peel layer.

The peel layer may be formed by dissolving or dispersing the acrylic copolymer resin having a solution acid value of 2 or less in a suitable solvent such as water to prepare a coating liquid for a peel layer, coating the coating liquid, for example, by gravure printing, screen printing, or reverse roll coating using a gravure plate, on the side of the substrate sheet opposite to the side where the heat resistant slip layer is provided, and drying the coating. The coated amount of the peel layer is from 0.1 g/m² to 10 g/m², preferably from 0.5 g/m² to 5 g/m², on a dry state.

### (Primer Layer)

The primer layer 4 in the present invention is provided between the peel layer and the adhesive layer on the substrate to enhance the adhesion between the peel layer and the adhesive layer. The primer layer used in the present invention is formed of inorganic fine particles. The inorganic fine particles are colloidal ultrafine particles of an inorganic pigment. Examples thereof include conventional compounds, for example, metal silicates such as aluminum silicate and magnesium silicate; metal oxides such as alumina or alumina hydrate (for example, alumina sol, colloidal alumina, cationic aluminum oxide or its hydrate, or pseudo-boehmite), silica or silica sol, magnesium oxide, and titanium oxide; carbonates such as magnesium carbonate; and the like. In the present invention, metal oxides and carbonates are preferred, metal oxides are more preferred, alumina or alumina hydrate is still more preferred, and alumina sol is particularly preferred because of high effect of imparting heat resistance and high toughness. The primer layer may be formed of only one type of colloidal inorganic pigment ultrafine particles. Alternatively, two or more types of colloidal inorganic pigment ultrafine particles may be used. In any event, any colloidal inorganic pigment ultrafine particles may be used so far as they do not have a phase transition temperature up to an instantaneous highest heating temperature from a thermal head in the printing.

The average particle diameter of the colloidal inorganic pigment ultrafine particles is generally 100 nm or less, preferably 50 nm or less, particularly preferably from 3 to 30 nm. In order that the colloidal inorganic pigment ultrafine particles can easily be dispersed in a sol form in an aqueous solvent, a dispersion stabilizer such as hydrochloric acid or acetic acid is incorporated to bring the colloidal inorganic pigment ultrafine particles to an acidic type, fine particle charges may be rendered cationic or the colloidal inorganic pigment ultrafine particles may be surface treated. The colloidal inorganic pigment ultrafine particles may be commercially available products such as Aluminasol 100 (manufactured by Nissan Chemical Industries Ltd.) and Aluminasol 200 (manufactured by Nissan Chemical Industries Ltd.).

The primer layer may be generally formed by coating a coating liquid for a primer layer, comprising colloidal inorganic pigment ultrafine particles onto a peel layer of a substrate sheet, and drying the coating. More preferably, the primer layer is formed by a sol-gel process. In the primer layer, a film is formed without use of any binder resin. Accordingly, heat resistance and toughness can be imparted to the protective layer. Further, the primer layer has good adhesion to adjacent layers (peel layer and adhesive layer). In the formation of the primer layer by the sol-gel process, the coating is dried, for example, by exposing the coating to hot air of from 90 to 130° C. so that the colloidal inorganic pigment ultrafine particles are changed from a sol form to a dried gel form. The coating liquid for a primer layer can be prepared by dispersing colloidal inorganic pigment ultrafine particles in an aqueous medium. Specifically, aqueous media in the coating liquid for a primer layer include water, water-soluble alcohols such as isopropyl alcohol, and mixed liquids composed of water and a water-soluble alcohol. Preferably, in the coating liquid for a primer layer, from 1 to 100 parts by mass of colloidal inorganic pigment ultrafine particles are contained based on 100 parts by mass of an aqueous medium.

The primer layer according to the present invention may be composed of the above inorganic fine particles alone. Alternatively, the primer layer may comprise the above inorganic fine particles and further a water-soluble resin or an emulsifiable hydrophilic resin. Specific examples of water-soluble resins include polyvinyl pyrrolidone resins, polyvinyl alcohol resins, hydrophilic urethane resins, hydroxylalkyl substituted derivatives of cellulose, polyacrylamides, poly(meth)acrylic acids, and their metal salts. The addition amount of the hydrophilic resin is preferably from 0 to 50% by mass of the total solid content of the primer layer. The primer layer may be formed by preparing the above coating liquid, coating the coating liquid by conventional means such as gravure printing, screen printing, or reverse roll coating using a gravure plate. The primer layer may be coated at an amount of from 0.01 to 10 g/m² on a dry state. The coated amount on a dry state is preferably 0.05 g/m² or more and 1.0 g/m² or less from the viewpoint of imparting excellent heat resistance and toughness.

In addition to meeting of stable separation requirement, an improvement in “rainbow-colored unevenness” (a phenomenon in which streak unevenness of rainbow color are observed in a printing flow direction) is required in the protective layer. The use of the colloidal inorganic pigment ultrafine particles in the primer layer can realize better effect of preventing a printing failure of the rainbow-colored unevenness.

### (Adhesive Layer)

The adhesive layer used in the present invention is formed on the primer layer provided in the protective layer transfer sheet according to the present invention and contains a thermoplastic resin. The adhesive layer has the function of adhering the protective layer to an object in the formation of a protective layer on an object such as a thermal transfer image receiving sheet using the protective layer transfer sheet according to the present invention.

The thermoplastic resin used in the adhesive layer according to the present invention is not particularly limited so far as it has adhesive properties upon heating. Such thermoplastic resins include ethylene-vinyl acetate copolymer resins, vinyl chloride-vinyl acetate copolymer resins, maleic acid-modified vinyl chloride-vinyl acetate copolymer resins, polyamide resins, polyester resins, polyethylene resins, ethylene-isobutyl acrylate copolymer resins, butyral resins, polyvinyl acetate and its copolymer resins, ionomer resins, acid-modified polyolefin resins, (meth)acrylic resins such as acrylic/methacrylic resins, acrylate resins, ethylene-(meth)acrylic acid copolymers, ethylene-(meth)acrylate copolymers, polymethyl methacrylate resins, cellulosic resins, polyvinyl ether resins, polyurethane resins, polycarbonate resins, polypropylene resins, epoxy resins, and phenolic resins, vinyl resins, maleic acid resins, alkyd resins, polyethylene oxide resins, urea resins, melamine resins, melamine-alkyd resins, silicone resins, rubber resins, styrene butadiene styrene block copolymers (SBS), styrene isoprene styrene block copolymers (SIS), styrene ethylene butylene styrene block copolymers (SEBS), and styrene ethylene propylene styrene block copolymers (SEPS). Among them, compositions which can be heat sealed at a temperature of 180° C. or below are preferred.

In the adhesive layer, in addition to the thermoplastic resin, the additives described in the section of the peel layer may be used. The adhesive layer may be coated at an amount of from 0.1 to 10 g/m² on a dry state. The coated amount is preferably 0.5 g/m² or more and 5.0 g/m² or less on a dry state from the view point of imparting excellent adhesion.

### (Thermally Transferable Coloring Material Layer)

In the present invention, a protective layer having a three layer structure of the peel layer, the primer layer, and the adhesive layer, and a thermally transferable coloring material layer may be formed in sequence on an identical substrate sheet. This construction is advantageous in that the thermally transferable coloring material layer and the protective layer can be transferred with one head of a thermal transfer printer, the necessity of providing a plurality of units of a thermal transfer sheet feed part and a winding part can be eliminated and, thus, the size of the thermal transfer printer can be reduced, and the complication of the transfer system of the printer can be avoided.

The thermally transferable coloring material layer may be either a coloring material layer (a thermal fusion ink layer) formed of a thermal fusion ink, or a coloring material layer (a dye layer) containing a sublimable dye. The thermal fusion ink used in the present invention comprises a coloring agent and a vehicle and, if necessary, various additives. Regarding the coloring agent, among organic or inorganic pigments or dyes, those which have a color density satisfying a requirement as a recording material and do not cause color change and fading upon exposure to light, heat, temperature and the like, are preferred. Further, materials, which develop a color upon heating, and materials, which develop a color upon contact with a material coated onto an object, are also usable. Further, regarding the coloring agent, in addition to cyan, magenta, yellow, black and the like, various other color coloring agents may be used.

The vehicle is composed mainly of wax. A mixture of wax with a drying oil, a resin, a mineral oil, cellulose, and a rubber derivative may also be used. Further, a thermal conductive material may be incorporated in the thermally transferable coloring material layer formed of a thermal fusion ink from the view point of imparting good thermal conductivity and thermal fusion transferability. Such thermal conductive materials include carbonaceous materials such as carbon black, aluminum, copper, tin oxide, and molybdenum disulfide. The thermally transferable coloring material layer may be formed on the substrate film using the thermal fusion ink by conventional method such as hot melt coating, hot lacquer coating, gravure coating, gravure reverse coating, and roll coating. The coated amount of the thermally transferable coloring material layer formed of the thermal fusion ink may be properly determined by taking into consideration, for example, required print density and heat sensitivity and is usually from 0.1 to 30 g/m² on a dry state.

The thermally transferable coloring material layer (dye layer) containing a sublimable dye is a solution or dispersion of a thermally transferable dye in a binder resin. The binder resin is preferably such that it has a suitable level of affinity for a dye, and, upon heating with a thermal head, the dye contained in the binder resin is sublimated and transferred (thermally transferred) onto an object. In this case, the binder resin as such is not transferred even upon heating. Such binder resins include, for example, cellulosic resins such as ethylcellulose, hydroxyethylcellulose, ethylhydroxyethylcellulose, hydroxypropylcellulose, methylcellulose, cellulose nitrate, cellulose acetate, and cellulose acetate butyrate; vinyl resins such as polyvinyl alcohol, polyvinyl acetate, polyvinyl butyral, polyacrylamide, and polyvinylpyrrolidone; polyesters, and polyamides.

The content of the dye in the thermally transferable coloring material layer varies depending upon the sublimation (fusion) temperature of the dye, dyeability and the like. The content of the dye, however, is preferably 30 parts or more by mass, more preferably from 30 to 300 parts by mass, based on 100 parts by mass of the binder resin. When the content of the dye is less than 30 parts by mass, the print density and heat sensitivity are low. On the other hand, when the content of the dye is more than 300 parts by mass, the storage stability and the adhesion of the thermally transferable coloring material layer onto the substrate film is lowered.

The dye used in the thermally transferable coloring material layer is thermally fused, diffused or sublimated and is transferred onto an object, and disperse dyes are particularly preferred. The dye is selected by taking into consideration, for example, sublimability (fusability), hue, lightfastness, and solubility in the binder resin. These dyes include, for example, diarylmethane dyes; triarylmethane dyes; thiazole dyes; methine dyes such as merocyanines; azomethine dyes typified by indoaniline dyes, acetophenoneazomethine dyes, pyrazoloazomethine dyes, imidazoleazomethine dyes, imidazoazomethine dyes, and pyridoneazomethine dyes; xanthene dyes; oxazine dyes; cyanomethylene dyes typified by dicyanostyrene dyes and tricyanostyrene dyes; thiazine dyes; azine dyes; acridine dyes; benzeneazo dyes; azo dyes such as pyridoneazo dyes, thiopheneazo dyes, isothiazoleazo dyes, pyrroleazo dyes, pyrrazoleazo dyes, imidazoleazo dyes, thiadiazoleazo dyes, triazoleazo dyes, and disazo dyes; spiropyran dyes; indolinospiropyran dyes; fluoran dyes; rhodaminelactam dyes; naphthoquinone dyes; anthraquinone dyes; and quinophthalone dyes.

The thermally transferable coloring material layer as the dye layer may be provided on the substrate film by a conventional method, for example, by dissolving or dispersing a dye and a binder resin in a solvent to prepare an ink composition for a thermally transferable coloring material layer, and coating the ink composition onto a substrate film by a method properly selected from conventional printing methods or coating methods. The coated amount of the dye layer is suitably from 0.2 to 5.0 g/m², preferably from 0.4 to 2.0 g/m², on a dry state.

Regarding the above thermally transferable coloring material layer, at least two thermally transferable coloring material layers different from each other in hue should be formed in sequence on a substrate sheet. In this case, constructions of the two or more thermally transferable coloring material layers include a construction in which two or more dye layers using a sublimable dye are used, a construction in which a combination of thermally transferable coloring material layers of a dye layer(s) and a thermal fusion ink(s) is used, and a construction in which two or more thermally transferable coloring material layers of a thermal fusion ink are used. In the present invention, a method is particularly preferably adopted in which a yellow coloring material layer, a magenta coloring material layer, and a cyan coloring material layer are formed in sequence as sublimable dye-containing thermally transferable coloring material layers on a substrate sheet to form a high-quality thermally transferred image which is comparable to full-color photograph images and is sharp by virtue of the prevention of deviation of print length between hues in a full-color thermally transferred image. In the case of thermally transferred images of black color letter or pattern, black can be provided by superimposing three colors of a yellow coloring material layer, a magenta coloring material layer, and a cyan coloring material layer as the dye layers. However, the additional provision of a coloring material layer formed of a black thermal fusion ink using a carbon black coloring agent on the substrate sheet is preferred. This construction can realize the formation of images which have a high black color density and are sharp.

### Second Aspect of the Invention

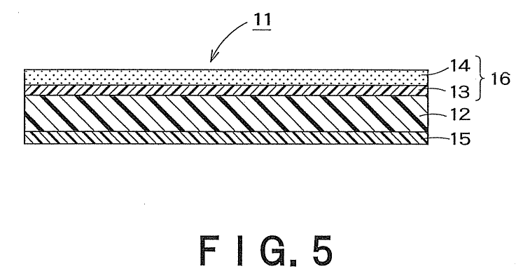

The second aspect of the present invention will be described. FIG. 5 is a schematic cross-sectional view showing second embodiment of a protective layer transfer sheet 11 in the second aspect of the present invention. The construction of the protective layer transfer sheet 11 is as follows. A peel layer 13 and an adhesive layer 14 are laminated in this order on one side of a substrate sheet 12. A heat resistant slip layer 15 is provided on the other side of the substrate sheet 12. The two layers of the peel layer 13 and the adhesive layer 14 constitute a protective layer 16. For example, the protective layer transfer sheet 11 is heated with a thermal head from the heat resistant slip layer 15 to transfer a protective layer 16 onto an object with an image, a letter or the like formed thereon by thermal transfer.

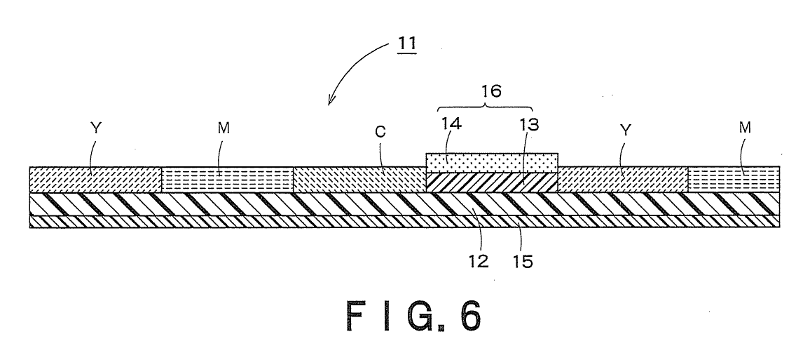

FIG. 6 is a schematic cross-sectional view showing another embodiment of the protective layer transfer sheet 11 in the second aspect of the present invention. The construction of the protective layer transfer sheet 11 is as follows. A heat resistant slip layer 15 is provided on one side of a substrate sheet 12. Dye layers containing sublimation dye as a thermally transferable coloring material layer are provided on the other side of the substrate sheet 12. Specifically, the dye layers comprise three color dye layers of a yellow dye layer Y, a magenta dye layer M, and a cyan dye layer C Further, after the formation of the cyan dye layer C, a protective layer 16 comprising two layers, i.e., a peel layer 13 and an adhesive layer 14 laminated on top of each other, is formed on the other side of the substrate sheet 12 in sequence. The dye layers and the protective layer 16 are repeatedly provided in a side-by-side relationship with each other. This embodiment is that a thermal transfer sheet comprises three-color dye layers and a protective layer integrated with each other.

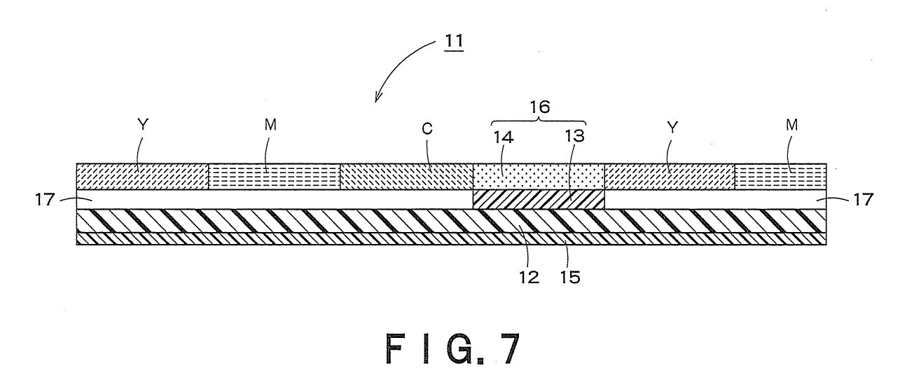

FIG. 7 is a schematic cross-sectional view showing still another embodiment of the protective layer transfer sheet 11 in the second aspect of the present invention. The construction of the protective layer transfer sheet 11 is as follows. A heat resistant slip layer 15 is provided on one side of a substrate sheet 12. Dye layers containing sublimation dye as a thermally transferable coloring material layer are provided on the other side of the substrate sheet 12 through a primer layer 17. Specifically, the dye layers comprise three color dye layers of a yellow dye layer Y, a magenta dye layer M, and a cyan dye layer C. Further, a protective layer 16 comprising three layers, i.e., a peel layer 13 and an adhesive layer 14 laminated on top of each other, is formed on the other side of the substrate sheet 12 in sequence. The dye layers and the protective layer 16 are repeatedly provided in a side-by-side relationship with each other. This embodiment is that three color dye layers are provided on a substrate sheet through a primer layer 17, and after the formation of the cyan dye layer C, a protective layer 16 comprising two layers of a peel layer 13 and an adhesive layer 14 laminated on top of each other, is formed in sequence. This embodiment is also a thermal transfer sheet comprising three color dye layers and a protective layer integrated with each other.

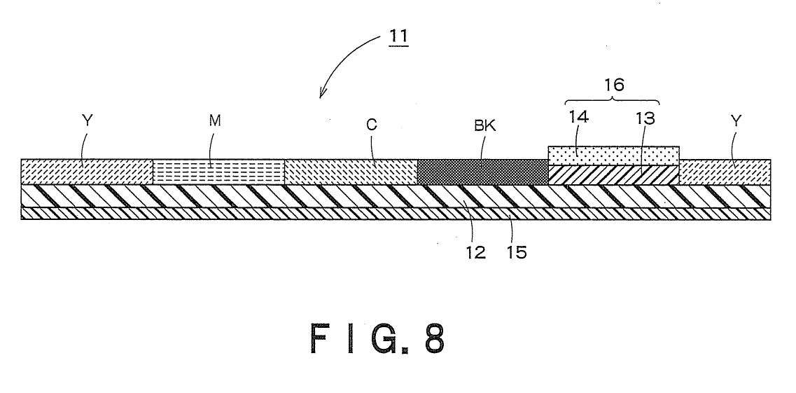

FIG. 8 is a schematic cross-sectional view showing a further embodiment of the protective layer thermal transfer sheet 11 in the second aspect of the present invention. The construction of the protective layer transfer sheet 11 is as follows. A heat resistant slip layer 15 is provided on one side of a substrate sheet 12. Dye layers containing sublimation dye as a thermally transferable coloring material layer and a black thermal-fusion ink layer BK are provided on the other side of the substrate sheet 12. Specifically, the dye layers comprise three color dye layers of a yellow dye layer Y, a magenta dye layer M, and a cyan dye layer C. Further, a protective layer 16 comprising two layers, i.e., a peel layer 13 and an adhesive layer 14 laminated on top of each other, is formed on the other side of the substrate sheet 12 in sequence. The dye layers and the protective layer 16 are repeatedly provided in a side-by-side relationship with each other. This embodiment is that a thermal transfer sheet comprises four-color thermally transferable coloring material layers of three dye layers and a black thermal-fusion ink layer and a protective layer integrated with each other. In addition to the embodiments shown in FIGS. 6 and 7 in which the thermally transferable coloring material layer is integrated with the protective layer, for example, various modified embodiments are possible, for example, an embodiment wherein thermally transferable coloring material layers having other color hues in addition to Y, M, C, and BK are added, and an embodiment wherein a thermally transferable coloring material layer of BK and a protective layer are integrated with each other.

Each layer constituting the protective layer transfer sheet in the second aspect of the present invention will be described in more detail.

### (Substrate Sheet)

The substrate sheet 12 in the protective layer thermal transfer sheet used in the present invention may be any conventional sheet having a certain level of heat resistance and strength. The thickness of the substrate sheet is, for example, from 0.5 to 50 μm, preferably from 1 to 10 μm, more preferably from 2 to 6 μm. For example, polyethylene terephthalate films, 1,4-polycyclohexylene dimethylene terephthalate films, polyethylene naphthalate films, polyphenylene sulfide films, polystyrene films, polypropylene films, polysulfone films, aramid films, polycarbonate films, polyvinyl alcohol films, cellophanes, cellulose derivatives such as cellulose acetate, polyethylene films, polyvinyl chloride films, nylon films, polyimide films, and ionomer films may be mentioned as specific examples of such substrate sheets. Among them, a polyester film formed of polyethylene terephthalate, polyethylene naphthalate, or a mixture thereof is preferred, and polyethylene terephthalate films are more preferred.

### (Heat Resistant Slip Layer)

In the present invention, the heat resistant slip layer 15 is provided on the side of the substrate sheet opposite to the side where the dye layer is provided to prevent thermal fusion of a heating device such as a thermal head to the substrate sheet and to realize smooth travelling. Resins usable in the heat resistant slip layer include conventional resins, for example, polyvinyl butyral resins, polyvinyl acetacetal resins, polyester resins, vinyl chloride-vinyl acetate copolymers, polyether resins, polybutadiene resins, styrene-butadiene copolymers, acryl polyols, polyurethane acrylates, polyester acrylates, polyether acrylates, epoxy acrylates, prepolymers of urethane or epoxy, nitrocellulose resins, cellulose nitrate resins, cellulose acetate propionate resins, cellulose acetate butyrate resins, cellulose acetate hydrogenphthalate resins, acetylcellulose resins, aromatic polyamide resins, polyimide resins, polyamideimide resins, polycarbonate resins, and chlorinated polyolefin resins.

Slipperiness-imparting agents added to or recoated on the heat resistant slip layer formed of the above resin include phosphoric esters, metallic soaps, silicone oils, graphite powder, silicone graft polymers, fluoro graft polymers, acrylsilicone graft polymers, acrylsiloxanes, arylsiloxanes, and other silicone polymers. Preferred is a layer formed of a polyol, for example, a high-molecular polyalcohol compound, a polyisocyanate compound and a phosphoric ester compound. Further, the addition of a filler is more preferred.

The heat resistant slip layer may be formed by dissolving or dispersing the above resin, slipperiness-imparting agent, and a filler in a suitable solvent to prepare a coating liquid for a heat resistant slip layer, coating the coating liquid onto a substrate sheet by forming means such as gravure printing, screen printing, or reverse roll coating using a gravure plate, and drying the coating. The coated amount of the heat resistant slip layer is preferably from 0.1 to 2.0 g/m² on a dry state.

### (Peel Layer)

The peel layer 13 in the protective layer transfer sheet according to the present invention is formed of an acrylic copolymer resin having a solution acid value of 2 or less. Examples of such resins include polymers produced by copolymerizing, for example, methyl methacrylate or styrene, with a monomer such as 2-hydroxyethyl methacrylate, N-methylolacrylamide, N-methylolmethacrylamide, 2-hydroxyethyl acrylate, 2-hydroxyethyl methacrylate, 2-hydroxypropyl acrylate, 2-hydroxypropyl methacrylate, 4-hydroxybutyl acrylate, 4-hydroxybutyl methacrylate, acrylic acid, methacrylic acid, 2-carboxy-1-butene, 2-carboxy-1-pentene, 2-carboxy-1-hexene, and 2-carboxy-1-heptene.

In the present invention, the acid value of the acrylic copolymer resin constituting the peel layer as measured in a solution state is 2 mg KOH/g or less. When the acid value is more than 2 mg KOH/g, a change in peel force between the substrate sheet and the peel layer in the protective layer transfer due to a variation in energy applied in the protective layer transfer is so large that separation failure takes place in the protective layer transfer. In order to produce an acrylic copolymer resin having an acid value of 2 mg KOH/g or less, a method may be adopted in which an acrylic monomer of the copolymer resin per se or an acrylic monomer composition comprising an acrylic monomer and other monomer(s) is regulated so as to have an acid value of 2 mg KOH/g or less and then polymerizing the acrylic monomer composition.

The peel layer may contain various additives such as waxes, inorganic fine particles or organic fine particles, ultraviolet absorbers, antioxidants, and fluorescent brightening agents in such amounts that do not impair the transparency of the protective layer. Such waxes include, for example, polyethylene waxes, polyester waxes, polystyrene powders, olefin powders, microcrystalline waxes, carnauba waxes, paraffin waxes, Fischer-Tropsh waxes, various low-molecular weight polyethylenes, Japan waxes, beeswaxes, spermaceti waxes, wool waxes, shellac waxes, candelilla waxes, petrolactam, partially modified waxes, fatty acid esters, and fatty amides. The use of these waxes can improve the scratch resistance and layer transferability of the peel layer.

For example, silica, alumina, titania, and calcium carbonate are usable as the inorganic fine particle of the additive. Organic fine particles include styrene fine particles, acrylic fine particles, and melamine resin fine particles. The addition of these fine particles is effective in improving the layer transferability and preventing rainbow-colored unevenness. Further, an ultraviolet absorber may be added to improve the lightfastness and weathering resistance of image and the like of an object covered with the protective layer. Ultraviolet absorbers include, for example, a wide variety of conventional organic ultraviolet absorbers, for example, salicylate, benzophenone, benzotriazole, substituted acrylonitrile, nickel chelate, or hindered amine ultraviolet absorbers. Further, an ultraviolet absorbing resin produced by introducing, for example, an addition-polymerizable double bond, such as a vinyl, acryloyl, or methacryloyl group, or an alcoholic hydroxyl, amino, carboxyl, epoxy, isocyanate or other functional group, into the ultraviolet absorber may be introduced into the peel layer.

The peel layer may be formed by dissolving or dispersing the acrylic copolymer resin having a solution acid value of 2 or less in a suitable solvent such as water to prepare a coating liquid for a peel layer, coating the coating liquid on the side of the substrate sheet opposite to the side where the heat resistant slip layer is provided, for example, by gravure printing, screen printing, or reverse roll coating using a gravure plate, and drying the coating. The coated amount of the peel layer is from 0.1 g/m² to 10 g/m², preferably from 0.5 g/m² to 5 g/m², on a dry state.

### (Adhesive Layer)

The adhesive layer 14 used in the present invention is formed on the peel layer provided in the protective layer transfer sheet according to the present invention and contains a thermoplastic resin. The adhesive layer has the function of adhering the protective layer to an object in the formation of a protective layer on an object such as a thermal transfer image receiving sheet using the protective layer transfer sheet according to the present invention.

The thermoplastic resin used in the adhesive layer according to the present invention is not particularly limited so far as it has adhesive properties upon heating. Such thermoplastic resins include, for example, ethylene-vinyl acetate copolymer resins, vinyl chloride-vinyl acetate copolymer resins, maleic acid-modified vinyl chloride-vinyl acetate copolymer resins, polyamide resins, polyester resins, polyethylene resins, ethylene-isobutyl acrylate copolymer resins, butyral resins, polyvinyl acetate and its copolymer resins, ionomer resins, acid-modified polyolefin resins, (meth)acrylic resins such as acrylic/methacrylic resins, acrylate resins, ethylene-(meth)acrylic acid copolymers, ethylene-(meth)acrylate copolymers, polymethyl methacrylate resins, cellulosic resins, polyvinyl ether resins, polyurethane resins, polycarbonate resins, polypropylene resins, epoxy resins, and phenolic resins, vinyl resins, maleic acid resins, alkyd resins, polyethylene oxide resins, urea resins, melamine resins, melamine-alkyd resins, silicone resins, rubber resin, styrene butadiene styrene block copolymers (SBS), styrene isoprene styrene block copolymers (SIS), styrene ethylene butylene styrene block copolymers (SEBS), and styrene ethylene propylene styrene block copolymers (SEPS). Among them, compositions which can be heat sealed at a temperature of 180° C. or below are preferred.

In the adhesive layer, in addition to the thermoplastic resin, the additives described in the section of the peel layer may be used. The adhesive layer may be coated at an amount of from 0.1 to 10 g/m² on a dry state. The coated amount is preferably 0.5 g/m² or more and 5.0 g/m² or less on a dry state from the view point of imparting excellent adhesion and the like.

### (Thermally Transferable Coloring Material Layer)

In the present invention, a protective layer having a two layer structure of the peel layer and the adhesive layer, and a thermally transferable coloring material layer may be formed in sequence on an identical substrate sheet. This construction is advantageous in that the thermally transferable coloring material layer and the protective layer can be transferred with one head of a thermal transfer printer, the necessity of providing a plurality of units of a thermal transfer sheet feed part and a winding part can be eliminated and, thus, the size of the thermal transfer printer can be reduced, and the complication of the transfer system of the printer can be avoided.

The thermally transferable coloring material layer may be either a coloring material layer (a thermal fusion ink layer) formed of a thermal fusion ink, or a coloring material layer (a dye layer) containing a sublimable dye. The thermal fusion ink used in the present invention comprises a coloring agent and a vehicle and, if necessary, various additives. Regarding the coloring agent, among organic or inorganic pigments or dyes, those which have a color density satisfying a requirement as a recording material and do not cause color change and fading upon exposure to light, heat, temperature and the like, are preferred. Further, materials, which develop a color upon heating, and materials, which develop a color upon contact with a material coated onto an object, are also usable. Further, regarding the coloring agent, in addition to cyan, magenta, yellow, black and the like, various other color coloring agents may be used.

The vehicle is composed mainly of wax. A mixture of wax with a drying oil, a resin, a mineral oil, cellulose, a rubber derivative or the like may also be used. Further, a thermal conductive material may be incorporated in the thermally transferable coloring material layer formed of a thermal fusion ink from the view point of imparting good thermal conductivity and thermal fusion transferability. Such thermal conductive materials include carbonaceous materials such as carbon black, aluminum, copper, tin oxide, and molybdenum disulfide. The thermally transferable coloring material layer may be formed on the substrate film using the thermal fusion ink by conventional method such as hot melt coating, hot lacquer coating, gravure coating, gravure reverse coating, and roll coating. The coated amount of the thermally transferable coloring material layer formed of the thermal fusion ink may be properly determined by taking into consideration, for example, required print density and heat sensitivity and is usually from 0.1 to 30 g/m² on a dry state.

The thermally transferable coloring material layer (dye layer) containing a sublimable dye is a dispersion or solution of a thermally transferable dye in a binder resin. The binder resin is preferably such that it has a suitable level of affinity for a dye, and, upon heating with a thermal head, the dye contained in the binder resin is sublimated and transferred (thermally transferred) onto an object. In this case, the binder resin as such is not transferred even upon heating. Such binder resins include, for example, cellulosic resins such as ethylcellulose, hydroxyethylcellulose, ethylhydroxyethylcellulose, hydroxypropylcellulose, methylcellulose, cellulose nitrate, cellulose acetate, and cellulose acetate-butyrate; vinyl resins such as polyvinyl alcohol, polyvinyl acetate, polyvinyl butyral, polyacrylamide, and polyvinylpyrrolidone; polyesters, and polyamides.

The content of the dye in the thermally transferable coloring material layer varies depending upon the sublimation (fusion) temperature of the dye, dyeability and the like. The content of the dye, however, is preferably 30 parts or more by mass, more preferably from 30 to 300 parts by mass, based on 100 parts by mass of the binder resin. When the content of the dye is less than 30 parts by mass, the print density and heat sensitivity are low. On the other hand, when the content of the dye is more than 300 parts by mass, the storage stability and the adhesion of the thermally transferable coloring material layer onto the substrate film is lowered.

The dye used in the thermally transferable coloring material layer is thermally fused, diffused or sublimated and is transferred onto an object, and disperse dyes are particularly preferred. The dye is selected by taking into consideration, for example, sublimability (fusability), hue, lightfastness, and solubility in the binder resin. These dyes include, for example, diarylmethane dyes; triarylmethane dyes; thiazole dyes; methine dyes such as merocyanines; azomethine dyes typified by indoaniline dyes, acetophenoneazomethine dyes, pyrazoloazomethine dyes, imidazoleazomethine dyes, imidazoazomethine dyes, and pyridoneazomethine dyes; xanthene dyes; oxazine dyes; cyanomethylene dyes typified by dicyanostyrene dyes and tricyanostyrene dyes; thiazine dyes; azine dyes; acridine dyes; benzeneazo dyes; azo dyes such as pyridoneazo dyes, thiopheneazo dyes, isothiazoleazo dyes, pyrroleazo dyes, pyrrazoleazo dyes, imidazoleazo dyes, thiadiazoleazo dyes, triazoleazo dyes, and disazo dyes; spiropyran dyes; indolinospiropyran dyes; fluoran dyes; rhodaminelactam dyes; naphthoquinone dyes; anthraquinone dyes; and quinophthalone dyes.

The thermally transferable coloring material layer as the dye layer may be provided on the substrate film by a conventional method, for example, by dissolving or dispersing a dye and a binder resin in a solvent to prepare an ink composition for a thermally transferable coloring material layer, and coating the ink composition onto a substrate film by a method properly selected from conventional printing methods or coating methods. The coated amount of the dye layer is suitably from 0.2 to 5.0 g/m², preferably from 0.4 to 2.0 g/m², on a dry state.

Regarding the above thermally transferable coloring material layer, at least two thermally transferable coloring material layers different from each other in hue should be formed in sequence on a substrate sheet. In this case, constructions of the two or more thermally transferable coloring material layers include a construction in which two or more dye layers using a sublimable dye are used, a construction in which a combination of thermally transferable coloring material layers of a dye layer(s) and a thermal fusion ink(s) is used, and a construction in which two or more thermally transferable coloring material layers of a thermal fusion ink are used. In the present invention, a method is particularly preferably adopted in which a yellow coloring material layer, a magenta coloring material layer, and a cyan coloring material layer are formed in sequence as sublimable dye-containing thermally transferable coloring material layers on a substrate sheet to form a high-quality thermally transferred image which is comparable to full-color photograph images and is sharp by virtue of the prevention of deviation of print length between hues in a full-color thermally transferred image. In the case of thermally transferred images of black color letter or pattern, black can be provided by superimposing three colors of a yellow coloring material layer, a magenta coloring material layer, and a cyan coloring material layer as the dye layers. Preferably, however, the additional provision of a coloring material layer formed of a black thermal fusion ink using a carbon black coloring agent on the substrate sheet is preferred. This construction can realize the formation of images which have a high black color density and are sharp.

### (Primer Layer)

A primer layer 17 can also be formed by coating between the substrate sheet and the thermally transferable coloring material layer and/or between the substrate sheet and the heat resistant slip layer. The primer layer may be formed of the following resin. Such resins include polyester resins, plyacrylic ester resins, polyvinyl acetate resins, polyurethane resins, styrene acrylate resins, polyacrylamide resins, polyamide resins, polyether resins, polystyrene resins, polyethylene resins, polypropylene resins, vinyl resins such as polyvinyl chloride resins, polyvinyl alcohol resins and polyvinylidene chloride resins, polyvinyl acetal resins such as polyvinyl acetoacetal and polyvinyl butyral, and cellulosic resins. The primer layer may be formed by a method properly selected from conventional printing methods and coating methods. The coated amount of the primer layer is from 0.2 to 5.0 g/m², preferably from 0.4 to 2.0 g/m² on a dry state.

### (Object to be Transferred)

In the protective layer transfer sheet according to the present invention, a protective layer may be transferred onto any object so far as a thermally transferred image can be formed on the object. The object and the protective layer transfer sheet are disposed on top of each other followed by heating to adhere both the object and the protective layer transfer sheet to each other and thus to prepare an assembly. In this sample, the protective layer transfer sheet is then separated from the object. In this case, the heating is performed with a test printer of a multi-pulse system, which has such a pulse length that one line period has been divided into 256 equal parts and wherein the number of divided pulses could be varied from 0 to 255 during one line period, by a gradation control method, under two levels of heating conditions of 120 pulse number (gradations) and 180 pulse number (gradations). The peel force at 180 gradations: peel force at 120 gradations ratio is less than 1.4 in the peel force between the peel layer and the substrate sheet as measured when separating the sample into the protective layer transfer sheet and the object by 180 degrees.

An example of the object is one having a construction comprising a conventional (dye) receptive layer provided on a substrate formed of various papers or plastic sheets. When the substrate has dyeing property with a dye, that is, when the substrate is formed of, for example, a flexible polyvinyl chloride resin, there is no need to provide any receptive layer and, in this case, the substrate as such may be used as the object. Such various papers include, for example, capacitor papers, glassine papers, parchment papers, or papers having a high sizing degree, synthetic papers (polyolefin or polystyrene papers), woodfree papers, art papers, coated papers, cast coated papers, wall papers, backing papers, synthetic resin- or emulsion-impregnated papers, synthetic rubber latex impregnated papers, synthetic resin internally added papers, board papers, and cellulose fiber papers.

Such various plastic sheets include, for example, polyesters, polyacrylates, polycarbonates, polyurethanes, polyimides, polyetherimides, cellulose derivatives, polyethylenes, ethylene-vinyl acetate copolymers, polypropylenes, polystyrenes, acrylic resins, polyvinyl chlorides, polyvinylidene chlorides, polyvinyl alcohols, polyvinyl butyrals, nylons, polyether ether ketones, polysulfones, polyether sulfones, tetrafluoroethylene/perfluoroalkyl vinyl ethers, polyvinyl fluorides, tetrafluoroethylene/ethylenes, tetrafluoroethylene/hexafluoropropylenes, polychlorotrifluoroethylenes, and polyvinylidene fluorides. White opaque sheets (films) obtained by adding a white pigment or a filler to the synthetic resin and forming a film from the mixture, or porous sheets (films) comprising microvoids in the inside of a substrate may also be used as the plastic sheet, and the plastic sheet is not particularly limited.

Further, a laminate comprising any combination of substrates of the above papers and plastic sheets may also be used. Typical examples of such laminates include a laminate of a cellulose fiber paper and a synthetic paper or a laminate of a cellulose fiber paper and a plastic sheet. The thickness of the object may be optionally selected and is generally about from 10 to 300 μm. When the protective layer transfer sheet according to the present invention is used, even upon a variation in conditions of the object (for example, thickness and thermal conductivity) or even upon a variation in conditions of the dye receptive layer (for example, type of resin and thickness), stable and good protective layer transfer can be realized by reducing peel force. Specifically, a sample is formed by disposing the protective layer transfer sheet and an object on top of each other, and heating the assembly to bond the object and the protective layer transfer sheet to each other with a printer, which can vary gradations in the range of 0 to 255 gradations by a gradation control method, under two levels of heating conditions of 120 gradations and 180 gradations. In this sample, the peel force at 180 gradations: peel force at 120 gradations ratio is less than 1.4 in the peel force as measured when separating the protective layer transfer sheet from the object to reduce the peel force. Further, when heating conditions for 120 gradations and heating conditions for 180 gradations using a printer, which can vary gradations in the range of 0 to 255 gradations by a gradation control method, are satisfied, printing conditions such as electric resistance value, print density, printing voltage, printing speed, and printing start temperature of the thermal head may be varied.

### EXAMPLES

Examples in First Aspect of Present Invention

The following Examples further illustrate the first aspect of the present invention. In the following description, “parts” or “%” is by mass unless otherwise specified.

### Example A1

The following coating liquid for a heat resistant slip layer was coated by using a gravure coater on one side of a substrate sheet of a 6 μm-thick continuous sheet of polyethylene terephthalate (Lumirror, manufactured by Toray Industries, Inc.) at an amount of 1.0 g/m² in terms of a solid content, and the coating was dried to form a heat resistant slip layer.

<Coating liquid for heat resistant slip layer>

| | | |
|---|---|---|
| Polyvinyl butyral resin | 13.6 | parts |
| (S-lec BX-1, manufactured by Sekisui | | |
| Chemical Co., Ltd.) | | |
| Polyisocyanate curing agent | 0.6 | part |
| (Takenate D218, manufactured by | | |
| Takeda Chemical Industries, Ltd.) | | |
| Phosphoric ester | 0.8 | part |
| (Plysurf A208S, manufactured by | | |
| Dai-Ichi Kogyo Seiyaku Co., Ltd.) | | |
| Methyl ethyl ketone | 42.5 | parts |
| Toluene | 42.5 | parts |

Next, an ink having the following composition was coated by using a gravure coater on the side of the substrate sheet opposite to the side where the heat resistant slip layer is provided to form a thermally transferable coloring material layer formed of dye layers, in which three colors constitute one set, so that each color has a size of 8 cm in length and 4 cm in width. In this case, the distance between individual sets was brought to 10 cm. The coated amount of the dye layer was 2.0 g/m2 on a dry state for each of the three colors.

<Composition of ink for yellow dye layer>

| | |
|---|---|
| Dye | 5.5 parts |
| (FORON BRILLIANT YELLOW S-6GL) | |
| Polyvinyl acetal resin | 4.5 parts |
| (tradename KS-5: manufactured by | |
| Sekisui Chemical Co., Ltd.) | |
| Polyethylene wax | 0.1 part |
| Solvent | 89 parts |
| (toluene: methyl ethyl ketone = 1:1 mass ratio) | |

<Composition of ink for magenta dye layer>

| | |
|---|---|
| Dye 1 | 1.5 parts |
| (MS RED-G) | |
| Dye 2 | 2.0 parts |
| (MACROLEX RED VIORET R) | |
| Polyvinyl acetal resin | 4.5 parts |
| (tradename KS-5: manufactured by | |
| Sekisui Chemical Co., Ltd.) | |
| Polyethylene wax | 0.1 part |
| Solvent | 89 parts |
| (toluene: methyl ethyl ketone = 1:1 mass ratio) | |

<Composition of ink for cyan dye layer>

| | |
|---|---|
| Dye | 1.5 parts |
| (Kayaset Blue 714) | |
| Polyvinyl acetal resin | 4.5 parts |
| (tradename KS-5: manufactured by | |
| Sekisui Chemical Co., Ltd.) | |
| Polyethylene wax | 0.1 part |
| Solvent | 89 parts |
| (toluene: methyl ethyl ketone = 1:1 mass ratio) | |

Next, the following coating liquid for a peel layer was coated by using a gravure coater between individual sets of the dye layer so that the coated amount of the peel layer was 1.0 g/m² on a dry state.

### <Coating Liquid for Peel Layer>

An acrylic copolymer resin was prepared by using methyl methacrylate as a main monomer so that the acid value of the solution was 0.2 mg KOH/g and was dissolved in a solvent (toluene: methyl ethyl ketone=1:1) so that a solid content was 20% by mass, whereby a coating liquid for a peel layer was prepared.

Next, the following coating liquid for a primer layer was coated by using a gravure coater on the peel layer so that the coated amount of the primer layer was 0.2 g/m² on a dry state.

<Coating liquid for primer layer>

| | |
|---|---|
| Aluminasol | 8.0 parts |
| (Aluminasol 200, average particle diameter: | |
| 10 to 20 nm, acetic acid stabilization type, | |
| manufactured by Nissan Chemical | |
| Industries Ltd.) | |
| Polyvinyl pyrrolidone resin | 2.0 parts |
| (PVP-K90, manufactured by ISP Japan Ltd.) | |
| Water | 45.0 parts |
| Isopropyl alcohol | 45.0 parts |

The following coating liquid for an adhesive layer was coated by using a gravure coater on the primer layer so that of the coated amount of the adhesive layer was 1.0 g/m² on a dry state. Thus a protective layer transfer sheet of Example A1 was produced. The positions of the protective layer and the thermally transferable coloring material layer are the same as those shown in FIG. 2.

<Coating liquid for adhesive layer>

| | |
|---|---|
| Vinyl chloride-vinyl acetate copolymer | 50 parts |
| (SOLVIN CNL, manufactured by Nisshin | |
| Chemical Industries Ltd.) | |
| Toluene | 50 parts |
| Methyl ethyl ketone | 50 parts |

### Example A2

A protective layer transfer sheet of Example A2 was produced in the same manner as in Example A1, except that the coating liquid for a peel layer of the protective layer transfer sheet of Example A1 was changed to the following coating liquid.

### <Coating Liquid for Peel Layer>

An acrylic copolymer resin was prepared by using methyl methacrylate as a main monomer so that the acid value of the solution was 0.6 mg KOH/g and was dissolved in a solvent (toluene: methyl ethyl ketone=1:1) so that a solid content was 20% by mass, whereby a coating liquid for a peel layer was prepared.

### Example A3

A protective layer transfer sheet of Example A3 was produced in the same manner as in Example A1, except that the coating liquid for a peel layer of the protective layer transfer sheet of Example A1 was changed to the following coating liquid.

### <Coating Liquid for Peel Layer>

An acrylic copolymer resin was prepared by using methyl methacrylate as a main monomer so that the acid value of the solution was 1.1 mg KOH/g and was dissolved in a solvent (toluene: methyl ethyl ketone=1:1) so that a solid content was 20% by mass, whereby a coating liquid for a peel layer was prepared.

### Example A4

A protective layer transfer sheet of Example A4 was produced in the same manner as in Example A2, except that the coating liquid for a heat resistant slip layer of the protective layer transfer sheet of Example A2 was changed to the following coating liquid and the coated amount of the heat resistant slip layer was brought to 0.5 g/m² in terms of a solid content.

<Coating liquid for heat resistant slip layer>

| | |
|---|---|
| Polyamideimide resin | 50 parts |
| (HR15ET manufactured by | |
| TOYOBO CO., LTD.) | |
| Polyamideimide silicone resin | 50 parts |
| (HR14ET manufactured by | |
| TOYOBO CO., LTD.) | |
| Polyester resin | 2 parts |
| (Vylon 220 manufactured by | |
| TOYOBO CO., LTD.) | |
| Zinc stearyl phosphate | 10 parts |
| (LBT 1830 manufactured by Sakai | |
| Chemical Co., Ltd.) | |
| Phosphoric ester | 5 parts |
| (Plysurf A208S manufactured | |
| by Dai-Ichi Kogyo Seiyaku Co., Ltd.) | |
| Talc (MICRO ACE P-3, manufactured by | 10 parts |
| Nippon Talc Co., Ltd) | |
| Ethanol | 570 parts |
| Toluene | 570 parts |

### Comparative Example A1

A protective layer transfer sheet of Comparative Example A1 was produced in the same manner as in Example A1, except that the coating liquid for a peel layer of the protective layer transfer sheet of Example A1 was changed to the following coating liquid.

<Coating liquid for peel layer>

| | |
|---|---|
| Polymethyl methacrylate resin | 20 parts |
| (acid value of solution 3.1 (mg KOH/g)) | |
| (DIANAL BR-87, manufactured by | |
| Mitsubishi Rayon Co., Ltd) | |
| Toluene | 40 parts |
| Methyl ethyl ketone | 40 parts |

The protective layer comprising the peel layer, the primer layer, and the adhesive layer of the protective layer transfer sheet produced in the above Examples and Comparative Example was transferred on an image receiving surface of a thermal transfer image-receiving sheet to form a protective layer. In this case, the separability of the protective layer transfer sheet was evaluated.

The evaluation was carried out by the following method.

### (Separability)

### <Printing Conditions>

Average resistance of heating element: 5176 Ω
Printing density in main scanning direction: 300 dpi, printing density in sub-scanning direction: 300 dpi
Printing voltage: 17 V
One line period: 10 msec/line
Printing initiation temp.: 35° C.
Gradation value: 255/255
Applied pulse (gradation control method): A test printer of a multi-pulse system was provided which had such a pulse length that one line period was divided into 256 equal parts and wherein the number of divided pulses could be varied from 0 to 255 during one line period. The duty ratio of each divided pulse was fixed at 85%. Under the above conditions, protective layers were formed on a thermal transfer image receiving sheet on two pulse number levels, i.e., a pulse number of 125 (which provides a lower transfer energy) and a pulse number of 230 (which provides a higher transfer energy). In this case, regarding the thermal transfer sheet and the protective layer transfer sheet, a sample was obtained by superimposing the thermal transfer sheet and the protective layer transfer sheet on top of each other, bonding the assembly for integration. That is, the assembly in which the protective layer transfer sheet had not been separated from the thermal transfer image receiving sheet was regarded as a sample.

### <Conditions for Separation>

The peel force necessary for separating the protective layer transfer sheet from the thermal transfer image receiving sheet was measured using the sample in such a state that the thermal transfer image receiving sheet and the protective layer transfer sheet had been bonded to each other. In this case, the peel force was measured as a peel force necessary for 180-degree peeling with the following device.
Peeling device: surface property measuring machine HEIDON-14 manufactured by Shinto Scientific Company Ltd.
   Peel rate: 200 mm/min
   Width of sample to be measured: 83 mm

In each of the protective layer transfer sheets of the Examples and the Comparative Example, the peel force was measured using two samples one of which had been allowed to stand at room temperature (20° C.) and the other had been stored for 30 days in an atmosphere of temperature 40° C and humidity 90% RH.

The results of measurement of the peel force are shown in Table 1.

TABLE 1

| | | Peel force (gf/83 mm) | | | |
|---|---|---|---|---|---|
| | | Stored at room | | After storage under | |
| | | temperature | | conditions of 40° C./ | |
| | Solution acid | Transfer | Transfer | 90% × 30 days | |
| | value | energy: | energy: | Transfer | Transfer |
| | (mgKOH/g) | low | high | energy: low | energy: high |
| Ex. A1 | 0.2 | 6 | 10 | 6 | 11 |
| Ex. A2 | 0.6 | 6 | 12 | 7 | 13 |
| Ex. A3 | 1.1 | 6 | 13 | 7 | 14 |
| Ex. A4 | 0.6 | 6 | 12 | 8 | 15 |
| Comp. | 3.1 | 7 | 34 | 11 | 306 |
| Ex. A1 | | | | | |

For the protective layer transfer sheets of Examples A1, A2, A3, and A4 and Comparative Example A1, regarding the peel force under the above conditions for peeling, when the energy in the protective layer transfer was low, no difference was observed between the sample stored at room temperature and the sample after storage under conditions of 40° C. and 90% RH. For the protective layer transfer sheet of Comparative Example A1, however, when the energy in the protective layer transfer is high, the peel force of the sample after storage under conditions of 40° C. and 90% RH was 9 times higher than the sample stored at room temperature. On the other hand, for the protective layer transfer sheets of Examples A1, A2, A3, and A4, when the energy in the protective layer transfer is high, the peel force of the sample after the storage under conditions of 40° C. and 90% RH did not reach two times the peel force of the sample stored at room temperature, that is, was not significantly different from the peel force of the sample stored at room temperature.

The results of measurement of the peel force mean that the protective layer transfer sheets of the Examples can prevent separation failure of the protective layer transfer caused by increased peel force between the substrate sheet and the peel layer, whereas, for the protective layer transfer sheet of the Comparative Example, after storage at elevated temperatures, the separation failure of the protective layer transfer takes place due to increased peel force between the substrate sheet and the peel layer.

It is considered that, upon storage of the protective layer transfer sheet for a long period of time or at elevated temperatures, the components in the primer layer migrate into the substrate sheet/peel layer interface to affect the peel force, that is, the components in the primer layer do not react with the peel layer and substrate sheet using an acrylic resin having a solution acid value of 2 or less to not cause a peel force change, whereas the components in the primer layer react with the peel layer and substrate sheet using an acrylic resin having a solution acid value of more than 2 to cause an increased peel force.

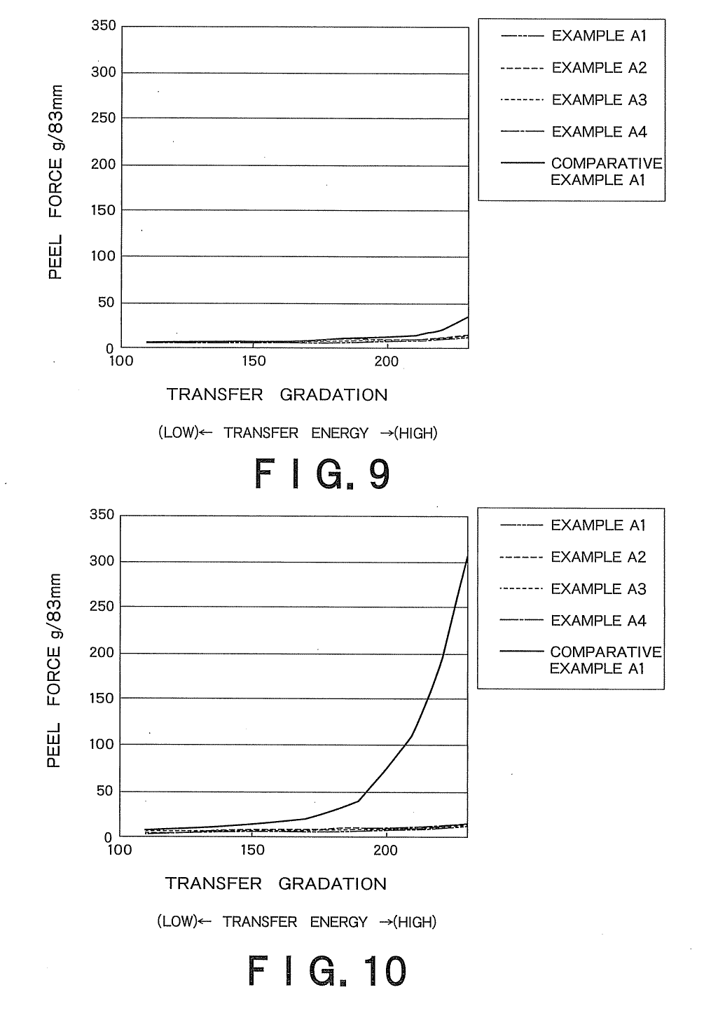

In the Examples and Comparative Example, the results of measurement of the peel force on two pulse number levels in the protective layer transfer, that is, a pulse number of 125 and a pulse number of 230, are shown in FIGS. 9 and 10. Specifically, FIG. 9 shows the relationship between the pulse number (transfer gradation) in the protective layer transfer in the sample which had been allowed to stand at room temperature (20° C.), and the peel force, that is, a change of peel force upon a continuous variation of pulse number. FIG. 10 shows the relationship between the pulse number (transfer gradation) of the protective layer transfer in the sample stored in an atmosphere of temperature 40° C. and humidity 90% RH for 30 days and the peel force, that is, a change of peel force upon a continuous variation of pulse number. For the protective layer transfer sheet of the Examples stored at room temperature, there was substantially no change of peel force upon a variation of pulse number. On the other hand, for the protective layer transfer sheet of the Comparative Example, when the pulse number was more than 200, the peel force was increased. Further, for the protective layer transfer sheets of the Examples after storage under conditions of temperature 40° C. and humidity 90% RH for 30 days, an increase of pulse number caused a slight increase of peel force but not a significant change of the peel force. On the other hand, for the protective layer transfer sheet of the Comparative Example, when the pulse number was more than 150, the peel force was increased. In this case, particularly when the pulse number was more than 200, the peel force was increased significantly.

### Examples in Second Aspect of Present Invention

The following Examples further illustrate the second aspect of the present invention. In the-following description, “parts” or “%” is by mass unless otherwise specified.

### Example B1

The following coating liquid for a heat resistant slip layer was coated by using a gravure coater on one side of a substrate sheet of a 6 μm-thick continuous sheet of polyethylene terephthalate (Lumirror, manufactured by Toray Industries, Inc.) at an amount of 1.0 g/m² in terms of a solid content, and the coating was dried to form a heat resistant slip layer.

<Coating liquid for heat resistant slip layer>

| | |
|---|---|
| Polyvinyl butyral resin | 13.6 parts |
| (S-lec BX-1, manufactured by Sekisui | |
| Chemical Co., Ltd.) | |
| Polyisocyanate curing agent | 0.6 part |
| (Takenate D218, manufactured by MITSUI | |
| CHEMICALS POLYURETHANES, INC.) | |
| Phosphoric ester | 0.8 part |
| (Plysurf A208N, manufactured by | |
| Dai-Ichi Kogyo Seiyaku Co., Ltd.) | |
| Methyl ethyl ketone | 42.5 parts |
| Toluene | 42.5 parts |

Next, an ink having the following composition was coated by using a gravure coater on the side of the substrate sheet opposite to the side where the heat resistant slip layer is provided to form a thermally transferable coloring material layer formed of dye layers, in which three colors constitute one set, so that each color has a size of 8 cm in length and 4 cm in width. In this case, the distance between individual sets was brought to 10 cm. The coated amount of the dye layer was 2.0 g/m² on a dry state for each of the three colors.

<Composition of ink for yellow dye layer>

| | |
|---|---|
| Dye | 5.5 parts |
| (FORON BRILLIANT YELLOW S-6GL) | |
| Polyvinyl acetal resin | 4.5 parts |
| (tradename KS-5: manufactured by | |
| Sekisui Chemical Co., Ltd.) | |
| Polyethylene wax | 0.1 part |
| Solvent | 89 parts |
| (toluene:methyl ethyl ketone = 1:1 mass ratio) | |

<Composition of ink for magenta dye layer>

| | |
|---|---|
| Dye 1 | 1.5 parts |
| (MS RED-G) | |
| Dye 2 | 2.0 parts |
| (MACROLEX RED VIORET R) | |
| Polyvinyl acetal resin | 4.5 parts |
| (tradename KS-5: manufactured by | |
| Sekisui Chemical Co., Ltd.) | |
| Polyethylene wax | 0.1 part |
| Solvent | 89 parts |
| (toluene:methyl ethyl ketone = 1:1 mass ratio) | |

<Composition of ink for cyan dye layer>

| | |
|---|---|
| Dye | 1.5 parts |
| (Kayaset Blue 714) | |
| Polyvinyl acetal resin | 4.5 parts |
| (tradename KS-5: manufactured by | |
| Sekisui Chemical Co., Ltd.) | |
| Polyethylene wax | 0.1 part |
| Solvent | 89 parts |
| (toluene:methyl ethyl ketone = 1:1 mass ratio) | |

Next, the following coating liquid for a peel layer was coated by using a gravure coater between individual sets of the dye layer so that the coated amount of the peel layer was 1.0 g/m² on a dry state.

### <Coating Liquid for Peel Layer>

An acrylic copolymer resin was prepared by using methyl methacrylate as a main monomer so that the acid value of the solution was 0.3 mg KOH/g and was dissolved in a solvent (toluene: methyl ethyl ketone=1:1) so that a solid content was 20% by mass, whereby a coating liquid for a peel layer was prepared.

The following coating liquid for an adhesive layer was coated by using a gravure coater on the peel layer so that the coated amount of the adhesive layer was 1.0 g/m² on a dry state. Thus a protective layer transfer sheet of Example B1 was produced. The positions of the protective layer and the thermally transferable coloring material layer are the same as those shown in FIG. 6.

<Coating liquid for adhesive layer>

| | |
|---|---|
| Vinyl chloride-vinyl acetate copolymer | 50 parts |
| (SOLVIN CNL, manufactured by Nisshin | |
| Chemical Industries Ltd.) | |
| Toluene | 50 parts |
| Methyl ethyl ketone | 50 parts |

### Example B2

A protective layer transfer sheet of Example B2 was produced in the same manner as in Example B1, except that the coating liquid for a peel layer of the protective layer transfer sheet of Example B1 was changed to the following coating liquid.

### <Coating Liquid for Peel Layer>

An acrylic copolymer resin was prepared by using methyl methacrylate as a main monomer so that the acid value of the solution was 1.1 mg KOH/g and was dissolved in a solvent (toluene: methyl ethyl ketone=1:1) so that a solid content was 20% by mass, whereby a coating liquid for a peel layer was prepared.

### Example B3

A protective layer transfer sheet of Example B3 was produced in the same manner as in Example B1, except that the coating liquid for a peel layer of the protective layer transfer sheet of Example B1 was changed to the following coating liquid.

### <Coating Liquid for Peel Layer>

An acrylic copolymer resin was prepared by using methyl methacrylate as a main monomer so that the acid value of the solution was 1.8 mg KOH/g and was dissolved in a solvent (toluene: methyl ethyl ketone=1:1) so that a solid content was 20% by mass, whereby a coating liquid for a peel layer was prepared.

### Comparative Example B1

A protective layer transfer sheet of Comparative Example B1 was produced in the same manner as in Example B1, except that the coating liquid for a peel layer in the protective layer transfer sheet of Example B1 was changed to the following coating liquid.

<Coating liquid for peel layer>

| | |
|---|---|
| Polymethyl methacrylate resin | 20 parts |
| (acid value of solution 3.1 (mg KOH/g)) | |
| (DIANAL BR-87, manufactured by | |
| Mitsubishi Rayon Co., Ltd) | |
| Toluene | 40 parts |
| Methyl ethyl ketone | 40 parts |

The protective layer comprising a peel layer and an adhesive layer in each of the protective layer transfer sheets produced in the Examples and Comparative Examples was transferred onto a receptive layer of a thermal transfer image receiving sheet (a sheet obtained by cutting an image receiving sheet for a Canon compact photoprinter CP 710 into an arbitrary size) with a test printer under the following conditions to prepare a “sample composed of the protective layer transfer sheet and the thermal transfer image receiving sheet bonded to each other,” and the peel force was measured under the following conditions.

### (Peel Force)

### <Printing Conditions>

Average resistance of heating element: 4885 Ω
Printing density in main scanning direction: 300 dpi, printing density in sub-scanning direction: 300 dpi
Printing voltage: 18 V
One line period: 2 msec/line
Printing initiation temp.: 27° C.
Gradation value: 255/255
Print width: 3 cm
Applied pulse (gradation control method): A test printer of a multi-pulse system was provided which had such a pulse length that one line period was divided into 256 equal parts and wherein the number of divided pulses could be varied from 0 to 255 during one line period. The duty ratio of each divided pulse was fixed at 90%. Under the above conditions, protective layers were formed on an object by heating on two pulse number levels, i.e., a pulse number of 120 (gradation) and a pulse number of 180 (gradation). In this case, regarding the object and the protective layer transfer sheet, a sample was obtained by superimposing the object and the protective layer transfer sheet on top of each other, bonding the assembly for integration. That is, an assembly in which the protective layer transfer sheet had not been separated from the object was regarded as a sample.

### <Conditions for Separation>

The peel force necessary for separating the protective layer transfer sheet from the object was measured using the sample in such a state that the object and the protective layer transfer sheet had been bonded to each other. In this case, the peel force was measured as a peel force necessary for 180-degree peeling with the following device.
Peeling device: universal material tester 5565, manufactured by Instron
Peel rate: 300 mm/min

Further, the adhesion between the protective layer and the substrate sheet and the plasticizer resistance of the prints were examined under the following conditions.

### (Adhesion)

For the protective layer transfer sheets produced in the Examples and Comparative Examples, a tape (Scotch Mending Tape MP-18) was applied onto the surface of the protective layer (adhesive layer). 10 min after the application, the tape was separated in a 90-degree direction at a rate of 0.6 m/min to inspect the sample for abnormal separation and thus to examine the adhesion between the protective layer and the substrate sheet, and the results were evaluated according to the following criteria.

◯: No separation from the substrate sheet

Δ: Separation of part of the protective layer from the substrate sheet

×: Complete separation of the protective layer from the substrate sheet

### (Plasticizer Resistance)

A protective layer was transferred onto an object with an image formed by thermal transfer using each of the protective layer transfer sheets of the Examples and the Comparative Example under the following conditions. The print with the protective layer transferred thereon was superimposed on a flexible vinyl chloride sheet containing a plasticizer added thereto (manufactured by Mitsubishi Chemical Corporation, Arutoron#480, thickness 400 μm) so that the image face of the print faced the vinyl chloride sheet. A load of 70.2 g/cm² was applied to the assembly followed by storage under an environment of 50° C. for 48 hr. Thereafter, a deterioration in image by the plasticizer was visually evaluated according to the following criteria.

◯: No image was transferred onto the vinyl chloride sheet.

Δ: A part of the image was transferred onto the vinyl chloride sheet.

×: The transfer of the image onto the whole vinyl chloride sheet was observed.

### <Printing Conditions>

Average resistance of heating element: 4885 Ω
Printing density in main scanning direction: 300 dpi, printing density in sub-scanning direction: 300 dpi
Printing voltage: 18 V
One line period: 2 msec/line
Printing initiation temp.: 27° C.
Gradation value: 255/255
Print width: 3 cm
Applied pulse (gradation control method): A test printer of a multi-pulse system was provided which had such a pulse length that one line period was divided into 256 equal parts and wherein the number of divided pulses could be varied from 0 to 255 during one line period. The duty ratio of each divided pulse was fixed at 90%. Yellow, magenta, and cyan colors were transferred in that order onto an object in its image receptive face to form a black image. A protective layer was then transferred and formed by printing at a pulse number of 255. The formation of a black image by yellow, magenta, and cyan, and the protective layer transfer were carried out using the protective layer transfer sheet produced in each of the Examples and Comparative Example.

The results of measurement of the peel force, data on the peel force at 180 gradations and data on the peel force at 120 gradations, and, further, the results of evaluation of the adhesion and plasticizer resistance are shown in Table 2.

TABLE 2

| | Solution | Peel | Peel | | | |
|---|---|---|---|---|---|---|
| | acid value | force; | force; | Peel force | | |
| | (mg | 120 | 180 | 180 gradations/peel force | | Plasticizer |
| | KOH/g) | gradations | gradations | 120 gradations | Adhesion | resistance |
| Ex. B1 | 0.3 | 7 | 9 | 1.3 | ◯ | ◯ |
| Ex. B2 | 1.1 | 9 | 12 | 1.3 | ◯ | ◯ |
| Ex. B3 | 1.8 | 9 | 12 | 1.3 | ◯ | ◯ |
| Comp. | 3.1 | 10 | 15 | 1.5 | ◯ | ◯ |
| Ex. B1 | | | | | | |

The above peel force is in gf/83 mm-width.

For the protective layer transfer sheets of Examples B1, B2, and B3, the peel force at 180 gradations is 1.3 times the peel force at 120 gradations and does not reach 1.4 times the peel force at 120 gradations. This indicates that, even when the applied energy in the protective layer transfer is increased, suppressed peel force, freedom from transfer failure of the protective layer, and stable transfer of the protective layer can be realized. On the other hand, for the protective layer transfer sheet of Comparative Example B1, the peel force at 180 gradations is 1.5 times the peel force at 120 gradations, that is, is more than 1.4 times the peel force at 120 gradations. This indicates that, when the applied energy is increased in the protective layer transfer, separation failure in the protective layer transfer takes place due to increased peel force between the substrate sheet and the peel layer. For all of Examples B1, B2, B 3, and Comparative Example B1, the evaluation of the adhesion and the plasticizer resistance was good.

Further, since the peel layer of each of the protective layer transfer sheets of Examples B1, B2 and B3 is formed of an acrylic copolymer resin having a solution acid value of 2 or less, even when the applied energy in the protective layer transfer is increased, the peel layer does not react with the substrate sheet and an increase in peel force is suppressed. On the other hand, the peel layer in the protective layer transfer sheet of Comparative Example B1 is formed of an acrylic resin having a solution acid value of more than 2, and it is considered that, when the applied energy in the protective layer transfer is increased, the peel layer reacts with the substrate sheet resulting in increased peel force.

1. A protective layer transfer sheet comprising: a substrate sheet; a heat resistant slip layer provided on one side of the substrate sheet; and a thermally transferable protective layer provided on at least a part of the other side of the substrate sheet opposite to the one side where the heat resistant slip layer is provided,
the protective layer comprising a peel layer, a primer layer, and an adhesive layer formed in this order from the substrate sheet side, and the peel layer being formed of an acrylic copolymer resin having a solution acid value of 2 or less.

2. The protective layer transfer sheet according to claim 1, wherein the primer layer is formed using a composition containing colloidal ultrafine particles of an alumina sol.

3. The protective layer transfer sheet according to claim 1, wherein the heat resistant slip layer is formed using a composition containing an isocyanate compound and a hydroxyl group-containing resin.

4. The protective layer transfer sheet according to claim 1, wherein the heat resistant slip layer contains a polyamide-imide resin.

5. A protective layer transfer sheet comprising: a substrate sheet; a heat resistant slip layer provided on one side of the substrate sheet; and a transferable protective layer provided on at least a part of the other side of the substrate sheet opposite to the one side where the heat resistant slip layer is provided,
the protective layer comprising a peel layer and an adhesive layer formed in this order from the substrate sheet side, and the peel layer being formed of an acrylic copolymer resin having a solution acid value of 2 or less.

6. The protective layer transfer sheet according to claim 5, wherein a sample is formed by disposing the protective layer transfer sheet and an object to be transferred on top of each other, heating the thus formed assembly with a printer, which can vary gradations in the range of from 0 to 255 gradations by a gradation control method, under two levels of heating conditions of 120 gradations and 180 gradations to adhere the object to the protective layer transfer sheet, and the peel force at 180 gradations : peel force at 120 gradations ratio is less than 1.4 in the peel force between the peel layer and the substrate sheet as measured when separating the sample into the protective layer transfer sheet and the object by 180 degrees.
